(19) United States
(12) Patent Application Publication
(10) Pub. No.: US 2016/0072337 A1
(43) Pub. Date: Mar. 10, 2016

(54) CASE AND APPARATUS INCLUDING THE SAME

(71) Applicant: Samsung Electro-Mechanics Co., Ltd., Suwon-si (KR)

(72) Inventors: Ki Won Chang, Suwon-Si (KR); Ji Hoon Kim, Suwon-Si (KR); Jae Suk Sung, Suwon-Si (KR); Choon Hee Kim, Suwon-Si (KR); Hyun Keun Lim, Suwon-Si (KR); Isaac Nam, Suwon-Si (KR)

(73) Assignee: Samsung Electro-Mechanics Co., Ltd., Suwon-si (KR)

(21) Appl. No.: 14/837,635

(22) Filed: Aug. 27, 2015

(30) Foreign Application Priority Data
Sep. 4, 2014 (KR) 10-2014-0117835
Apr. 23, 2015 (KR) 10-2015-0056927

(51) Int. Cl. H02J 7/02; H02J 7/00

(52) U.S. Cl. CPC H02J 7/025; H02J 7/0044; H02J 2007/0096

(57) ABSTRACT

A case includes a casing region made of metal and configured to cover at least a portion of an apparatus, and a coil electrically insulated from the casing region and having a ring shape or a polygonal shape having ends separated from each other, the coil being configured to be disposed outside the apparatus.

### CROSS-REFERENCE TO RELATED APPLICATION(S)

This application claims the benefit under 35 USC 119(a) of Korean Patent Application Nos. 10-2014-0117835 filed on Sep. 4, 2014, and 10-2015-0056927 filed on Apr. 23, 2015, in the Korean Intellectual Property Office, the entire disclosures of which are incorporated herein by reference for all purposes.

### BACKGROUND

1. Field

This application relates to a case including a coil for receiving power wirelessly or performing near-field communication, and an apparatus including the same.

2. Description of Related Art

In accordance with the development of wireless technology, various wireless functions ranging from the transmission of data to the transmission of power have been implemented. In accordance with the trend for mobile devices such as cellular phones, tablets, and other mobile devices to be protected from water and dust, wireless power reception technology is increasingly being demanded in mobile devices. In addition, in order to perform a function such as electronic payment approval or other function requiring data communication using a mobile device, near-field communication functionality is also being demanded in mobile devices.

Mobile devices such as cellular phones, tablets, and other mobile devices have increasingly been provided with metal cases due to a customer demand. However, when a rear surface of the mobile device is formed by a metal case, even in the case that a coil for wirelessly receiving power or performing near-field communication is disposed in the metal case, the power may not be wirelessly received or data may not be transmitted and received due to the metal case.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a case includes a casing region made of metal and configured to cover at least a portion of an apparatus; and a coil electrically insulated from the casing region and having a ring shape or a polygonal shape having ends separated from each other, the coil being configured to be disposed outside the apparatus.

The casing region may include a region corresponding to a rear surface of the apparatus.

The coil may be configured to substantially surround an edge of the apparatus.

The coil may be disposed in a position corresponding to an edge of the rear surface of the apparatus.

The coil may be constituted by a single conductive wire.

The coil may include two or more turns.

The coil may have a length of 95% or more of a length of an edge of the casing region.

The case may further include an insulating portion disposed between the casing region and the coil.

The coil may be configured to receive power wirelessly.

The coil may be configured to receive or transmit data wirelessly.

In another general aspect, an apparatus includes a body; and a case including a casing region made of metal and covering at least a portion of the body, and a coil electrically insulated from the casing region and having a ring shape or a polygonal shape having ends separated from each other, the coil being disposed outside the body.

The body may include a wireless charging module configured to rectify power wirelessly received through the coil to charge a battery with power.

The body may include a near-field communication (NFC) module configured to transmit and receive data through the coil.

The body may include a wireless charging module configured to rectify power wirelessly received through the coil to charge a battery with power; a near-field communication (NFC) module configured to transmit and receive data through the coil; and a switch portion configured to selectively connect the coil to the NFC module or the wireless charging module in response to a signal received by the coil.

The coil may substantially surround an edge of the body.

The coil may be disposed along an edge of a rear surface of the body.

In another general aspect, a case of an apparatus includes a metal portion constituting at least a portion of a rear surface of the apparatus; and a coil electrically insulated from the metal portion and constituting a portion of an exterior surface of the apparatus.

The coil may have two ends separated by a gap, and may constitute a portion of an edge surface of the apparatus, or a portion of the rear surface of the apparatus substantially surrounding the metal portion.

The coil may constitute a portion of an edge surface of the apparatus; and the case may further include an insulating portion constituting another portion of the side surface of the apparatus and being disposed between the coil and the metal portion to electrically insulate the coil from the metal portion.

The coil may constitute another portion of the rear surface of the apparatus substantially surrounding the metal portion; and the case may further include an insulating portion constituting another portion of the rear surface of the apparatus and being disposed between the coil and the metal portion to electrically insulate the coil from the metal portion.

Other features and aspects will be apparent from the following detailed description, the drawings, and the claims.

### BRIEF DESCRIPTION OF THE DRAWINGS

FIG. 1 is a view illustrating an example of an exterior configuration of an apparatus.

FIG. 2 is a view illustrating another example of an exterior configuration of an apparatus.

FIG. 3 is a view illustrating an example of an internal circuit of the apparatus.

FIGS. 4 through 7 are views illustrating examples of configurations in which the apparatus receives power wirelessly from a wireless power transmitter.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

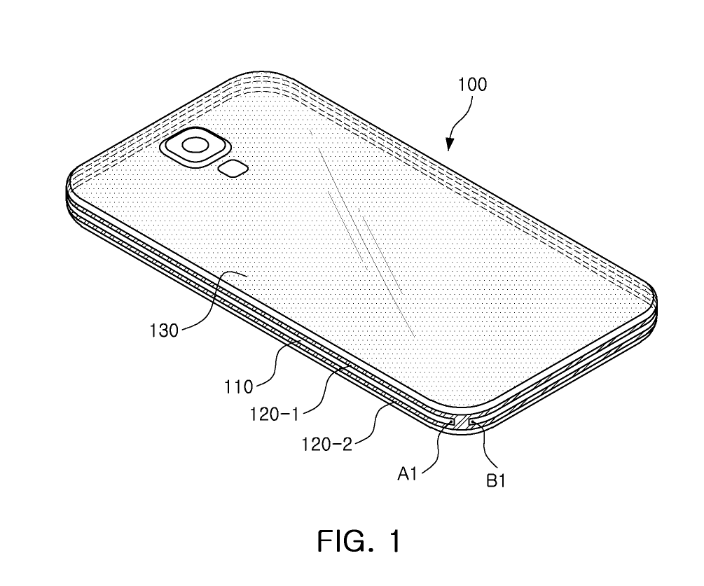

FIG. 1 is a view illustrating an example of an exterior configuration of an apparatus 100, and illustrates a perspective view of a rear surface of the apparatus 100 in a case in which the apparatus 100 is a mobile device such as a smartphone. In FIG. 1, reference numeral 110 denotes a receiving coil formed on a side surface of the apparatus 100, reference numerals 120-1 and 120-2 denote insulating portions, and reference numeral 130 denotes a rear surface of the apparatus. A portion of the case of the apparatus 100 is formed by the receiving coil 110, the insulating portions 120-1 and 120-2, and the rear surface 130. The rear surface 130 is a casing region that surrounds at least a portion of the apparatus 100.

In a case in which the rear surface 130 of the apparatus 100 is made of metal, the receiving coil 110 is formed along an edge of the apparatus 100, thereby allowing the apparatus 100 to receive power wirelessly. In the example in FIG. 1, the receiving coil 110 is a single conductive wire formed along the edge of the apparatus 100. Although FIG. 1 illustrates a case in which the receiving coil 110 is a single conductive wire formed across almost the entire edge of the apparatus 100, the receiving coil 110 may also be formed across the entire edge and may also be formed only in a portion of the edge. In addition, the receiving coil 110 may be formed to have a large number of turns along the edge of the apparatus 100. The receiving coil 110 may have a ring shape or a polygonal shape having ends that are separated from each other.

The insulating portion 120-1 is disposed between the receiving coil 110 and the rear surface 130 of the apparatus 100. Thus, the receiving coil 110 and the rear surface 130 of the apparatus 100 made of metal are electrically insulated from each other.

The insulating portion 120-2 is also disposed between the receiving coil 110 and a front surface of the apparatus 100. However, in a case in which a material of the front surface of the apparatus 100 is not made of metal, the insulating portion 120-2 may be omitted.

Alternatively, the edge of the apparatus 100 may include the insulating portions 120-1 and 120-2 and the receiving coil 110. In this case, other portions of the edge of the apparatus 100, that is, a portion thereof between the insulating portion 120-1 and the rear surface 130 of the apparatus 100 and a portion thereof between the insulating portion 120-2 and the front surface of the apparatus 100 may be made of metal.

Ends A1 and B1 of the receiving coil 110 are connected to an internal circuit of the apparatus.

Although FIG. 1 illustrates a case in which the receiving coil 110 is formed separately on the edge of the apparatus 100, the edge of the apparatus 100 may be formed of metal and may also be used as a receiving coil for receiving power wirelessly. In detail, the receiving coil 110 may be formed using a method of forming the edge of the apparatus 100 using metal and then forming the insulating portions 120-1 and 120-2.

The case of the apparatus 100 including the receiving coil 110, the insulating portions 120-1 and 120-2, and the rear surface 130 of the apparatus 100 may be integrally formed by a method such as insert injection molding, or any other suitable method. In this case, the ends Al and B1 of the receiving coil 110 may be provided with a terminal or a lead wire that is electrically connected to the internal circuit of the apparatus 100.

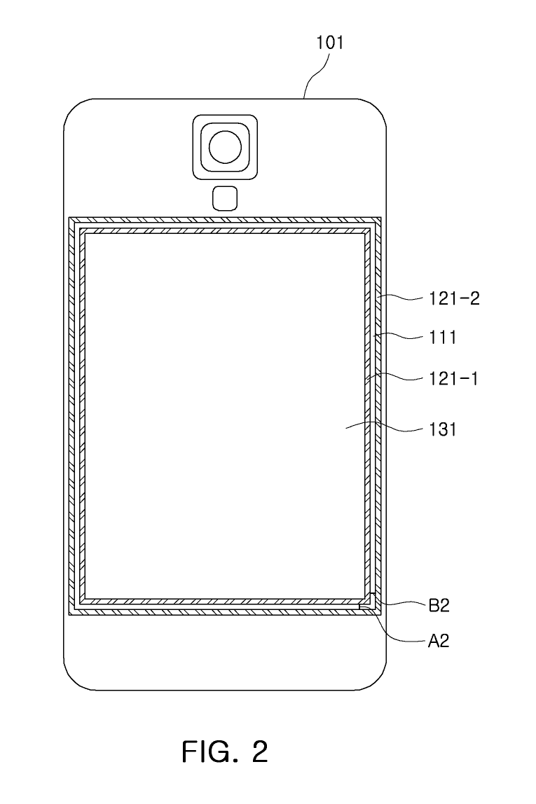

FIG. 2 is a view illustrating another example of an exterior configuration of an apparatus 101, and illustrates a rear surface of the apparatus 101 in a case in which the apparatus 101 is a mobile device such as a smartphone. In FIG. 2, reference numeral 111 denotes a receiving coil formed on a rear surface of the apparatus 101, reference numerals 121-1 and 121-2 denote insulating portions, and reference numeral 131 denotes the rear surface of the apparatus 101. A portion of the case of the apparatus 101 is formed by the receiving coil 111, the insulating portions 121-1 and 121-2, and the rear surface 131. The rear surface 131 is a casing region that surrounds at least a portion of the apparatus 101.

In the case of the apparatus 101, when the rear surface 131 of the apparatus 101 is made of metal, the receiving coil 111 is formed along an edge of the rear surface 131 of the apparatus 101, thereby allowing the apparatus 101 to receive power wirelessly. In the example in FIG. 2, the receiving coil 111 is a single conductive wire formed along the edge of the rear surface 131 of the apparatus 101. Although FIG. 2 illustrates a case in which the receiving coil 111 is a single conductive wire formed across almost the entire edge of the rear surface 131 of the apparatus 101, the receiving coil 110 may also be formed across the entire edge and may also only be formed in a portion of the edge. In addition, the receiving coil 111 may be formed to have a large number of turns along the edge of the rear surface 131 of the apparatus 101. The receiving coil 111 may have a ring shape or a polygonal shape having ends that are separated from each other.

The insulating portions 121-1 and 121-2 are disposed between the receiving coil 111 and the rear surface 131 of the apparatus 101. As a result, the receiving coil 111 and the rear surface 131 of the apparatus 101 made of metal are electrically insulated from each other.

In a case in which portions of the apparatus 101 except for the rear surface 131 formed inwardly of the receiving coil 111, and in a case in which sides of the apparatus are formed of a non-metallic material, the insulating portion 121-2 may be omitted.

Ends A2 and B2 of the receiving coil 111 are connected to an internal circuit of the apparatus.

The case of the apparatus 101 including the receiving coil 111, the insulating portions 121-1 and 121-2, and the rear surface 131 of the apparatus 101 may be integrally formed by a method such as insert injection molding, or any other suitable method. In this case, the ends A2 and B2 of the receiving coil 111 may be provided with a terminal or a lead wire that is electrically connected to the internal circuit of the apparatus 101.

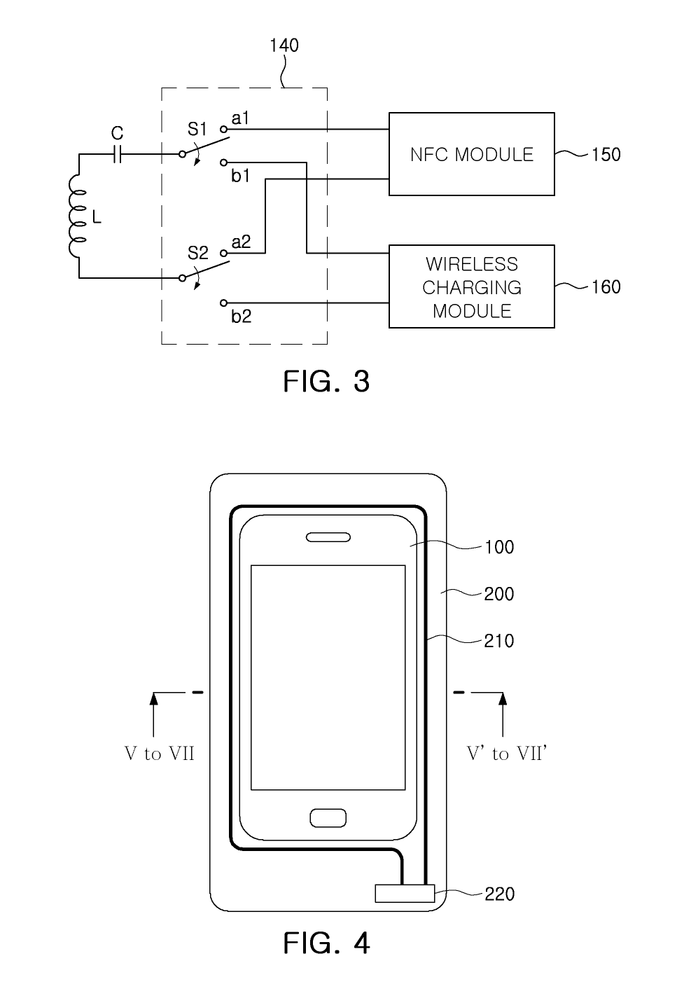

FIG. 3 is a view illustrating an example of an internal circuit of the apparatus. The body of the apparatus includes a printed circuit board (PCB) including the internal circuit, and in the example in FIG. 3, the internal circuit of the apparatus includes a capacitor C, a switch portion 140, a near-field communication (NFC) module 150, and a wireless charging module 160. In FIG. 3, reference numeral L denotes a receiving coil, for example, the receiving coil 110 of FIG. 1 or the receiving coil 111 of FIG. 2.

The receiving coil L receives power wirelessly from an external power source. The receiving coil L may also wirelessly receive a data signal in addition to the power. The receiving coil L and the capacitor C form a resonance tank.

The switch portion 140 includes switches S1 and S2, and transfers the power wirelessly received by the receiving coil L to the wireless charging module 160, or transfers the data signal received by the receiving coil L to the NFC module 150. The switches S1 and S2 of the switch portion 140 may be controlled in response to an input from a user, and may also be controlled according to an amplitude of the signal received by the receiving coil L. For example, when the amplitude of the signal received by the receiving coil L is equal to or higher than a reference amplitude, the signal received by the receiving coil L may be determined to be the power that is wirelessly received, and the switches S1 and S2 may be controlled to connect the switch S1 to a terminal b1 and connect the switch S2 to a terminal b2 to connect the receiving coil L and the capacitor C to the wireless charging module 160. Alternatively, when the amplitude of the signal received by the receiving coil L is lower than the reference amplitude, the signal received by the receiving coil L may be determined to be the data signal, and the switches S1 and S2 may be controlled to connect the switch S1 to a terminal al and connect the switch S2 to a terminal a2 to connect the receiving coil L and the capacitor C to the NFC module 150.

The NFC module 150 enables the apparatus to transmit and receive data to and from other external apparatuses.

The wireless charging module 160 may include a rectifier, a regulator, and other charging components, and may transfer the power that is wirelessly received to a battery (not illustrated) or other energy storage device of the apparatus.

Although FIG. 3 illustrates a case in which the switch portion 140 includes two switches S1 and S2, the switch S2 may be omitted in a case in which a terminal a2 and a terminal b2 are connected to a common ground.

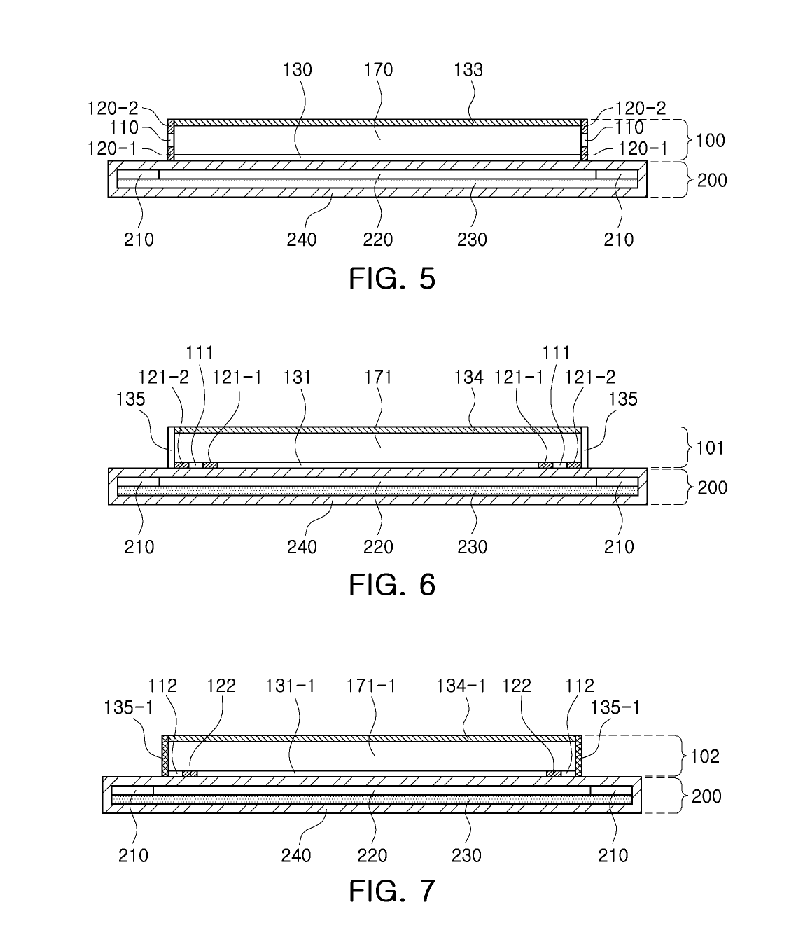

FIGS. 4 through 7 are views illustrating examples of configurations in which an apparatus wirelessly receives power from a wireless power transmitter 200. In detail, FIG. 4 illustrates a plan view of an apparatus in a case in which the apparatus has the configuration of FIG. 1 or FIG. 2, FIG. 5 illustrates a cross-sectional view of an apparatus in the case in which the apparatus has the configuration of FIG. 1, and FIGS. 6 and 7 illustrate cross-sectional views of an apparatus in a case in which the apparatus has the configuration of FIG. 2. In FIGS. 4 through 7, reference numeral 210 denotes a transmitting coil of the wireless power transmitter 200, reference numeral 220 denotes a power source portion of the wireless power transmitter 200, reference numeral 230 denotes a ferrite sheet of the wireless power transmitter 200, and reference numeral 240 denotes a case of the wireless power transmitter 200.

As illustrated in FIG. 4, in order to wirelessly transmit power to the apparatus 100, the transmitting coil 210 of the wireless power transmitter 200 is formed to surround the receiving coil 110 of the apparatus 100. In detail, in order to wirelessly transmit power, the receiving coil 110 of the apparatus 100 is disposed within the transmitting coil 210 of the wireless power transmitter 200.

Although FIG. 4 illustrates a case in which the transmitting coil 210 has a single winding, the transmitting coil 210 may have a two or more windings.

Table 1 illustrates simulation results for self-inductances of the receiving coil 110 (FIGS. 1 and 4), mutual inductances between the receiving coil 110 and the transmitting coil 210 (FIG. 4), and coupling coefficients between the receiving coil 110 and the transmitting coil 210 according to distances between the ends A1 and B1 (FIG. 1) of the receiving coil 110 in the apparatus 100 having an edge length of 384 mm. The edge length is a length measured along the entire edge of the apparatus 100.

TABLE 1

| | Distances Between Ends A1 and A2 of | | | | |
|---|---|---|---|---|---|
| | Receiving Coil | | | | |
| Classification | 0 mm | 5 mm | 10 mm | 20 mm | 30 mm |
| Self-Inductance | 0.293 | 0.292 | 0.289 | 0.299 | 0.255 |
| Mutual Inductance | 0.166 | 0.166 | 0.165 | 0.168 | 0.143 |
| Coupling Coefficient | 0.473 | 0.473 | 0.474 | 0.472 | 0.440 |

It can be seen from Table 1 that the self-inductance, the mutual inductance, and the coupling coefficient barely change up to the distance between the ends A1 and B1 of the receiving coil 110 of 20 mm, which is about 5% of the edge length of 384 mm of the apparatus, as compared to a case in which the distance between the ends A1 and B1 of the receiving coil 110 is 0 mm, that is, a case in which the receiving coil entirely surrounds the edge when viewed from above. In other words, when the receiving coil is formed along 95% or more of the edge, a sufficiently high value of wireless charging efficiency may be achieved.

FIG. 5 illustrates an example of a configuration in which the apparatus 100 wirelessly receives power from the wireless power transmitter 200, and illustrates a cross-sectional view of a case in which the apparatus 100 having the configuration of FIG. 1 is disposed on the wireless power transmitter 200 to wirelessly receive power. The apparatus 100 includes the rear surface 130, the insulating portions 120-1 and 120-2, the receiving coil 110, a front surface 133, and a body 170.

When viewed from above, the receiving coil 110 of the apparatus 100 is disposed outside the rear surface 130 of the apparatus 100 made of metal. The insulating portion 120-1 is disposed between the receiving coil 110 and the rear surface 130 of the apparatus 100. In addition, the insulating portion 120-2 is disposed between the receiving coil 110 and the front surface 133 of the apparatus 100. However, in a case in which the front surface 133 of the apparatus 100 is not made of metal, there is no need to insulate the front surface 133 of the apparatus 100 and the receiving coil 110 from each other, so the insulating portion 120-2 may be omitted.

The front surface 133 of the apparatus 100, which is provided to protect a display device, is made of a transparent material. The front surface 133 of the apparatus 100 may also be extended to portions of the side surface of the apparatus 100.

The capacitor C, the switch portion 140, the NFC module 150, and the wireless charging module 160 illustrated in FIG. 3 are disposed in the body 170 of the apparatus 100.

The transmitting coil 210 of the wireless power transmitter 200 is disposed outside the receiving coil 110 of the apparatus 100.

FIGS. 6 and 7 illustrate examples of a configuration in which the apparatus wirelessly receives power from the wireless power transmitter, and illustrate cross-sectional views of the apparatus in a case in which the apparatus having the configuration of FIG. 2 is disposed on the wireless power transmitter to wirelessly receive power. Referring to FIG. 6, an apparatus 101 includes include a rear surface 131, a receiving coil 111, insulating portions 121-1 and 121-2, an edge 135, a front surface 134, and a body 171. Referring to FIG. 7, an apparatus 102 includes a rear surface 131-1, a receiving coil 112, an insulating portion 122, an edge 135-1, a front surface 134-1, and a body 171-1.

The receiving coil 111 or 112 is disposed outside the rear surface 131 or 131-1 of the apparatus 101 or 102. The insulating portion 121-1 or 122 is disposed between the receiving coil 111 or 112 and the rear surface 131 or 131-1 of the apparatus 101 or 102.

As illustrated in FIG. 6, for example, when the edge 135 of the apparatus 101 is made of metal, the insulating portion 121-2 is disposed between the edge 135 of the apparatus 101 and the receiving coil 111. As illustrated in FIG. 7, in a case in which the edge 135-1 of the apparatus 102 is made of a non-metallic material, the insulating portion 121-2 in FIG. 6 not disposed between the edge 135-1 of the apparatus 102 and the receiving coil 112.

The front surface 134 or 134-1 of the apparatus 101 or 102, which is to protect a display device, is made of a transparent material. The front surface 134 or 134-1 of the apparatus 101 or 102 may also be extended to portions of the side surface of the apparatus 101 or 102.

The capacitor C, the switch portion 140, the NFC module 150, and the wireless charging module 160 illustrated in FIG. 3 are disposed in the body 171 or 171-1 of the apparatus 101 or 102.

The transmitting coil 210 of the wireless power transmitter 200 is disposed outside the receiving coil 111 or 112 of the apparatus 101 or 102.

In the examples described above, even in the case that the rear surface of the apparatus that is in contact with the wireless power transmitter is made of metal, the apparatus is able to wirelessly receive power transmitted by the transmitting coil of the wireless power transmitter.

In the examples described above, the apparatus is able to wirelessly receive power or transmit and receive data without affecting a design of the apparatus even in a case in which the metal case is used.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A case comprising:
a casing region made of metal and configured to cover at least a portion of an apparatus; and
a coil electrically insulated from the casing region and having a ring shape or a polygonal shape having ends separated from each other, the coil being configured to be disposed outside the apparatus.

2. The case of claim 1, wherein the casing region comprises a region corresponding to a rear surface of the apparatus.

3. The case of claim 2, wherein the coil is configured to substantially surround an edge of the apparatus.

4. The case of claim 2, wherein the coil is disposed in a position corresponding to an edge of the rear surface of the apparatus.

5. The case of claim 1, wherein the coil is constituted by a single conductive wire.

6. The case of claim 1, wherein the coil comprises two or more turns.

7. The case of claim 1, wherein the coil has a length of 95% or more of a length of an edge of the casing region.

8. The case of claim 1, further comprising an insulating portion disposed between the casing region and the coil.

9. The case of claim 1, wherein the coil is configured to receive power wirelessly.

10. The case of claim 1, wherein the coil is configured to receive or transmit data wirelessly.

11. An apparatus comprising:
a body; and
a case comprising:
a casing region made of metal and covering at least a portion of the body; and
a coil electrically insulated from the casing region and having a ring shape or a polygonal shape having ends separated from each other, the coil being disposed outside the body.

12. The apparatus of claim 11, wherein the body comprises a wireless charging module configured to rectify power wirelessly received through the coil to charge a battery with power.

13. The apparatus of claim 11, wherein the body comprises a near-field communication (NFC) module configured to transmit and receive data through the coil.

14. The apparatus of claim 11, wherein the body comprises:
a wireless charging module configured to rectify power wirelessly received through the coil to charge a battery with power;
a near-field communication (NFC) module configured to transmit and receive data through the coil; and
a switch portion configured to selectively connect the coil to the NFC module or the wireless charging module in response to a signal received by the coil.

15. The apparatus of claim 11, wherein the coil substantially surrounds an edge of the body.

16. The apparatus of claim 11, wherein the coil is disposed along an edge of a rear surface of the body.

17. A case of an apparatus, the case comprising:
a metal portion constituting at least a portion of a rear surface of the apparatus; and
a coil electrically insulated from the metal portion and constituting a portion of an exterior surface of the apparatus.

18. The case of claim 17, wherein the coil has two ends separated by a gap, and constitutes a portion of an edge surface of the apparatus, or a portion of the rear surface of the apparatus substantially surrounding the metal portion.

19. The case of claim 17, wherein the coil constitutes a portion of an edge surface of the apparatus; and
the case further comprises an insulating portion constituting another portion of the side surface of the apparatus and being disposed between the coil and the metal portion to electrically insulate the coil from the metal portion.

20. The case of claim 17, wherein the coil constitutes another portion of the rear surface of the apparatus substantially surrounding the metal portion; and
the case further comprises an insulating portion constituting another portion of the rear surface of the apparatus and being disposed between the coil and the metal portion to electrically insulate the coil from the metal portion.
